(19) United States
(12) Patent Application Publication
(10) Pub. No.: US 2026/0254916 A1
(43) Pub. Date: Aug. 27, 2026

(54) METHOD AND SYSTEM FOR DETERMINING AN OPTIMIZED SET OF INK COLOURS USED TO PRINT A PATTERN ON AN OBJECT

(71) Applicants: Airbus (S.A.S.), Blagnac (FR); Airbus Operations (S.A.S.), Toulouse (FR); Airbus Operations GmbH, Hamburg (DE)

(72) Inventors: Fabian Mahler, Hamburg (DE); Boris Moriniere, Rochefort (FR); Olivier Bürgy, Toulouse (FR); Samuel Leleu, Toulouse (FR)

(73) Assignees: Airbus (S.A.S.), Blagnac (FR); Airbus Operations (S.A.S.), Toulouse (FR); Airbus Operations GmbH, Hamburg (DE)

(21) Appl. No.: 19/545,352

(22) Filed: Feb. 20, 2026

(30) Foreign Application Priority Data
Feb. 24, 2025 (EP) 25305241

(51) Int. Cl. H04N 1/60

(52) U.S. Cl. CPC H04N 1/605

(57) ABSTRACT

A method implemented by a computer device for defining sets of different colors in a color space, each of which consists of spot colors that make it possible to reproduce one or more sensitive colors of the reference pattern to be printed continuously and exactly, and of process colors to be used to produce color combinations, so as to be able to obtain all of the colors of the reference pattern to be printed, other than the one or more sensitive colors, in the livery, and for selecting one of these sets of colors taking into account at least one selection criterion, in order to obtain a set of colors that is optimized in particular in terms of precision and or ink consumption.

### TECHNICAL FIELD

The disclosure herein relates to a method and system for determining an optimized set of different ink colors that are intended to be used to print at least one pattern on an object.

### BACKGROUND

The disclosure herein applies more particularly to the printing of representations of colors, texts, logos, images, artistic drawings, etc. on a three-dimensional object. This three-dimensional object may be large, such as an aircraft for example.

An aeronautical livery, in particular a livery of a civil transport aircraft, generally contains large areas of solid colors corresponding to the identification colors of the airline that will operate the aircraft. For such a livery, precise colorimetry of the colors is expected, in particular for identification colors.

One known painting process for obtaining such a livery requires meticulous preparation of the surface to be painted and tedious masking and unmasking steps, in addition to environmental constraints associated with manual or automatic paint application and challenging working conditions for operators.

Painting without masking using robot-driven digital printing makes it possible to solve the above problems. Such printing, called direct-to-shape printing (or DTS for short), is a printing technology that makes it possible to carry out printing directly on the three-dimensional surface of an object, regardless of its shape or texture.

The standard approach in the printing industry, and in particular in the context of direct-to-shape printing, to achieve a given color is based on intelligent placement of differently sized dots of primary colors or spot colors, typically cyan, magenta, yellow and black. The printed colors obtained using this approach are commonly called “process colors”. The use of just these primary color inks limits the options for printable colors.

It may therefore be difficult to precisely achieve a specific color (which must be reproduced precisely) with such process colors, in particular when implementing direct-to-shape printing, because a curvature of the object and/or path affects resolution and screening.

There is therefore a need to find a solution that makes it possible to maximize color precision, that is to say that makes it possible to obtain, with great precision, the desired colors in the printing that is carried out, and also, if possible, to reduce or even minimize ink consumption.

### SUMMARY

The disclosure herein aims to propose such a solution. To this end, it relates to a method for determining an optimized set of N different ink colors that are intended to be used to print at least one pattern, referred to as a reference pattern, on an object.

According to the disclosure herein, the method comprises at least the sequence of the following steps:
an analysis step, implemented by a computer device, for analyzing colorimetric data relating to the reference pattern to be printed, in order to identify a set of colors to be printed;
an identification step for identifying, among this set of colors, a number M of what are referred to as sensitive colors, M being an integer greater than or equal to 1;
a determination step for determining, for each identified sensitive color, what is referred to as a spot color intended to reproduce the sensitive color, and for entering each spot color thus determined into the computer device;
a definition step, implemented by the computer device, for defining a plurality of sets of colors, each of the sets of colors comprising N different colors consisting of the M spot colors and N-M colors referred to as elementary colors, at least the N-M elementary colors being intended to be used as process colors; and
a selection step, implemented by the computer device, for selecting one of the sets of colors taking into account at least one selection criterion, the set of colors thus selected representing the determined optimized set.

In the context of the disclosure herein, when colors are mentioned, this refers to ink colors (intended to be used for printing on an object).

Moreover, in the context of the disclosure herein:
a “sensitive color” is understood to mean a color that is to be reproduced precisely in the livery with respect to the pattern to be reproduced. In the case of printing on an aircraft, this may be a color characteristic of the airline that will operate the aircraft;
a “spot color” is understood to mean a color generated by an ink (which is pure or obtained from a mixture) that is printed in a single pass of a printing tool; and
a “process color” is understood to mean a color that is combined with one or more other process colors so as to form a given color. Such a given color is produced by printing a series of dots of generally different process colors.

Thus, by virtue of the disclosure herein, in order to print a reference pattern, provision is made for a hybrid approach using:
on the one hand, one or more spot colors that make it possible to reproduce (continuously) the one or more sensitive colors of the reference pattern to be printed exactly; and
on the other hand, process colors intended to be used to produce color combinations, via dot printing of process colors, in order to be able to obtain all of the colors (of the reference pattern) to be printed, other than the one or more sensitive colors, in the livery.

In addition, the process colors are selected using one or more particular selection criteria, which make it possible, as explained below, to obtain a set of colors that is optimized, primarily with regard to color precision, but also with regard to ink consumption.

The disclosure herein is thus particularly well suited to printing a reference pattern comprising a limited number of different colors that are to be reproduced exactly, as is the case in particular for printing identification patterns of an airline on an aircraft.

In a first embodiment, the selection step uses, as a selection criterion, what is referred to as a precision criterion that reflects the precision of the livery obtained by a set of colors with respect to the reference pattern, and the selection step comprises:
a sub-step for determining a value of the precision criterion for each of the sets of colors defined in the definition step; and
a sub-step for comparing the values of the precision criterion of each of the sets of colors with one another, and for selecting the set of colors whose precision criterion value reflects the best precision.

Moreover, in a second embodiment, in addition to or as a variant of the first embodiment, the selection step uses, as a selection criterion, what is referred to as a consumption criterion that reflects ink consumption (in terms of overall volume, in terms of overall cost, in terms of volume or in terms of cost of certain inks, etc.) with regard to each of the sets of colors defined in the definition step, for printing the reference pattern, and comprises:
a sub-step for determining a value of the consumption criterion for each of the sets of colors defined in the definition step; and
a sub-step for comparing the values of the consumption criterion of each of the sets of colors with one another, and for selecting the set of colors whose consumption criterion value reflects the lowest consumption.

Moreover, advantageously, the determination step comprises the following sub-steps for determining a spot color for each selected sensitive color:
a sub-step for preparing multiple inks of different colors, referred to as test colors, each time from a mixture of available inks, having colors close to the sensitive color under consideration;
a sub-step for measuring a value of a color difference parameter (preferably deltaE, as explained below) of each of these test colors of the prepared inks, with respect to the sensitive color; and
a selection sub-step for selecting the test color having the lowest color difference parameter value as spot color.

Furthermore, in one particular embodiment, at least one spot color of the set of colors is taken into consideration in the set of colors to also be used as a process color.

Moreover, advantageously, the method comprises a reception step, prior to the analysis step, in which the computer device receives the colorimetric data of the reference pattern to be printed.

In addition, advantageously, the elementary colors comprise at least some of the following colors:
primary colors: cyan, magenta, yellow;
secondary colors: orange, green, purple;
black.

The disclosure herein also relates to a printing method for printing a reference pattern on an object, using a printing system comprising at least one printing tool using N inks.

According to the disclosure herein, the printing tool uses, as N inks, respectively, the N inks selected beforehand using the abovementioned method.

The disclosure herein furthermore relates to a system for determining an optimized set of N different ink colors that are intended to be used to print at least one pattern, referred to as a reference pattern, on an object.

According to the disclosure herein, the system comprises at least:
a computer device configured at least:
to analyze colorimetric data relating to the reference pattern to be printed, in order to identify a set of colors to be printed;
to define a plurality of sets of colors, each of the sets of colors comprising N different colors consisting of M spot colors and N-M colors referred to as elementary colors, at least the N-M elementary colors being intended to be used as process colors; and
to select one of the sets of colors taking into account at least one selection criterion, the set of colors thus selected representing the determined optimized set; and
a set of devices configured at least to determine, for each of a plurality of identified colors, referred to as sensitive colors, what is referred to as a spot color intended to reproduce the sensitive color.

### BRIEF DESCRIPTION OF THE DRAWINGS

The appended figures will make it easy to understand how the disclosure herein may be implemented. In these figures, identical reference signs denote similar elements.

FIG. 1 is a block diagram of a method for determining an optimized set of different ink colors that are intended to be used to print at least one reference pattern on an object.

FIG. 2 schematically shows a system configured to implement the method of FIG. 1.

FIG. 3 is a block diagram of one example of a printing system able to carry out direct-to-shape printing, using the optimized set determined by the method of FIG. 1.

FIG. 4 schematically shows a color space showing the colors of the reference pattern to be printed.

FIG. 5 illustrates part of the color space from FIG. 4, showing a sensitive color and multiple corresponding test colors.

### DETAILED DESCRIPTION

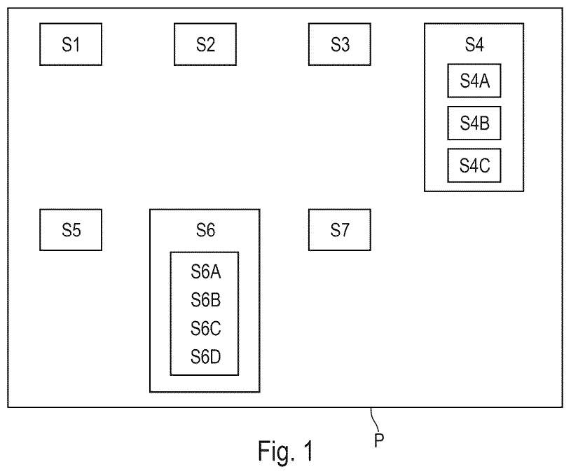

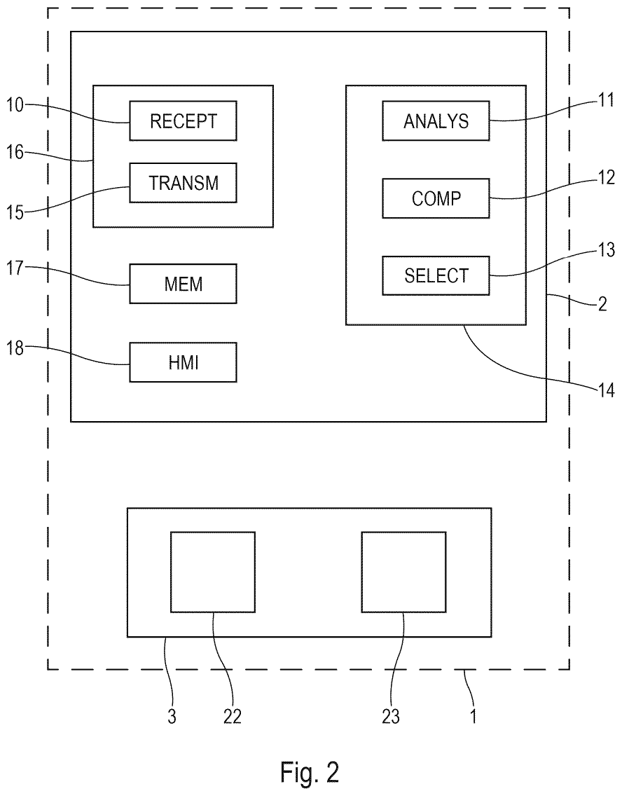

In the context of the disclosure herein, a method P (for example such as the one shown in one particular embodiment in FIG. 1) able to be implemented by a system 1 (for example such as the one shown in one particular embodiment in FIG. 2) is intended to determine an optimized set of inks of different colors, which will be used to print at least one given pattern (referred to as a reference pattern) on an object.

This reference pattern corresponds to a color representation that is intended to be printed on the object and that comprises for example images, texts, logos, artistic drawings, etc. This reference pattern may correspond to the whole representation to be printed on the object or to only part of this representation. In the latter case, the whole representation may comprise multiple reference patterns, each of which is printed on part of the object.

In the context of the disclosure herein, an “object” is understood to mean any apparatus, machine or other mechanical element or part of such an apparatus, machine or other mechanical element a surface or part of a surface of which is able to receive such printing. It may in particular be the fuselage of an aircraft on which characteristic signs (logos, colors, etc.) of the airline that will operate the aircraft will be printed.

The set of colors (inks), determined by the system 1 by implementing the method P, will preferably be used when implementing direct-to-shape (DTS) printing, which is a printing technology that makes it possible to carry out printing directly on the three-dimensional surface of an object, regardless of its shape or texture.

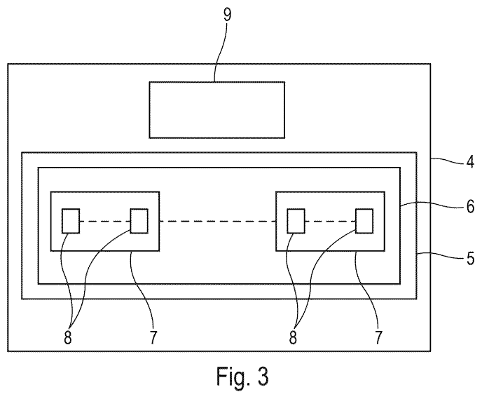

Direct-to-shape printing may be implemented using a printing system 4, for example such as the one shown schematically in FIG. 3, which comprises at least one robot 5. The robot 5 may be configured to carry out any type of movement (linear movement, rotary movement, complex articulation, etc.) and may correspond for example to a robotic arm or a Cartesian gantry. The robot 5 comprises a printing tool 6 (printing end-effector) at a free end. This printing tool 6 is provided with a plurality of N print heads 7, for example with six print heads, each of which comprises an ink of a different color. Each of these print heads 7 is in particular equipped with a plurality of nozzles 8 for projecting drops of ink on demand.

The printing tool 6 uses, as N inks, respectively, the N inks selected beforehand using the method P. The printing system 4 also comprises a control unit 9 intended in particular to control the movement of the robot 5 and the printing operations carried out by the printing tool 6.

Moreover, the system 1 comprises in particular, as shown in FIG. 2, a computer device 2 enabling operations to be carried out automatically and a set of devices 3 enabling an operator to carry out various actions, as explained below.

The method P implemented by the system 1 therefore aims to determine an optimized set of N colors (inks).

To this end, the method P comprises, as shown in FIG. 1, in particular the following steps, implemented by the system 1:
a reception step S1, implemented by a reception unit 10 (RECEPT) of the computer device 2 (FIG. 2), for receiving at least colorimetric data relating to the reference pattern to be printed;
an analysis step S2, implemented by an analysis unit 11 (ANALYS) of the computer device 2, for analyzing colorimetric data relating to the reference pattern to be printed, in order to identify a set of colors to be printed;
an identification step S3 enabling an operator to identify, among this set of colors, a number M of what are referred to as sensitive colors, M being an integer greater than or equal to 1;
a determination step S4 enabling an operator to determine, using the set of devices 3, for each identified sensitive color, what is referred to as a spot color intended to reproduce the sensitive color, each spot color thus determined being entered into the computer device 2;
a definition step S5, implemented by a computing unit 12 (COMP) of the computer device 2, for defining a plurality of sets of colors, each of the sets of colors comprising N different colors consisting of the M spot colors and N-M colors referred to as elementary colors, at least the N-M elementary colors being intended to be used as process colors;
a selection step S6, implemented by a selection unit 13 (SELECT) of the computer device 2, for selecting one of the sets of colors (defined in the definition step S5) taking into account at least one selection criterion. The set of colors thus selected represents the optimized set determined by the method P; and
a transmission step S7, implemented by a transmission unit 15 (TRANSM) of the computer device 2, for transmitting the optimized set to a user device (not shown), for example a computer, which may form part of the set of devices 3.

The various steps of the method P will now be described in more detail.

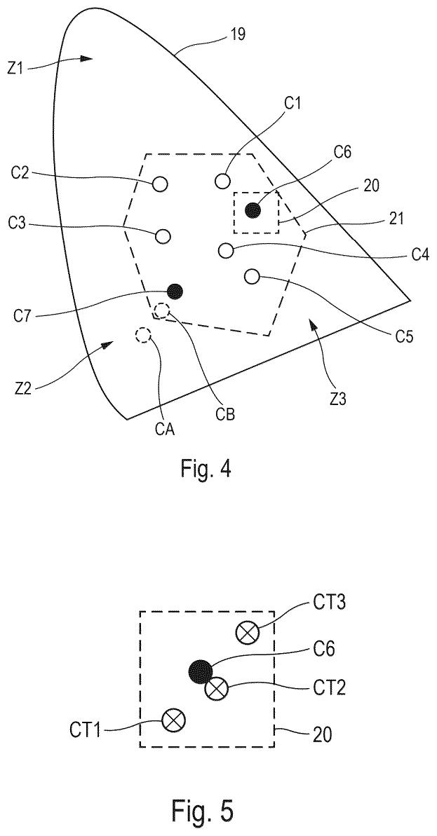

In the reception step S1, the computer device 2 receives the colorimetric data of the reference pattern to be printed, for example by way of a file containing these colorimetric data, which is loaded into the computer device 2. These colorimetric data may be stored in a memory 17 (MEM) of the computer device 2 (FIG. 2). These colorimetric data comprise references of the various colors present in the reference pattern. Preferably, these references represent coordinates of these colors in a color space, such as the color space 19 shown highly schematically in FIG. 4.

A color space, for example the CIELAB color space, is a three-dimensional mathematical model representing all colors able to be perceived, used or reproduced by a human being or a device. Each color that it contains is thus associated with coordinates (in the color space) defining a precise point.

The color space 19 shown in FIG. 4 comprises various areas where one color is predominant each time. To simplify the drawing, only zones Z1, Z2 and Z3 where certain colors are predominant, for example green, blue and red, respectively, have been localized.

In the following analysis step S2, the analysis unit 11 of the computer device 2 analyzes the colorimetric data relating to the reference pattern to be printed, as received in reception step S1, in order to identify a set of colors to be printed. More precisely, the analysis unit 11 identifies the various colors contained in the reference pattern and that are to be printed in order that the livery that is obtained reproduces this reference pattern as exactly as possible.

By way of illustration, the location of the various colors C1 to C7 that are present in the reference pattern and that have been identified by the analysis unit 11 is shown in the color space 19 of FIG. 4.

The set of colors C1 to C7 thus identified by the computer device 2 is provided to an operator, for example by being displayed on a screen of the computer device 2, by being stored on a removable memory, by being printed or being transmitted to a user device (not shown), for example a computer, of the operator.

This set of colors comprises a number L of colors. Thus, in the case of simple printing requiring few colors, the number L may be a small number, for example less than 20. On the other hand, in the case of complex printing, for example of a highly realistic photo requiring a wide range of colors, the number L may be very high.

An operator who has taken note of this set of colors C1 to C7 identifies, in the identification step S3, a number M of what are referred to as sensitive colors in this set of colors. As indicated above, a sensitive color is a color of the reference pattern that is to be reproduced precisely in the livery. In the case of printing on an aircraft, this may be a color characteristic of the airline that will operate the aircraft.

M (the number of sensitive colors) is an integer greater than or equal to 1 and less than or equal to N (the number of inks of different colors that may be used to print the reference pattern). Preferably, N is greater than or equal to 4 and less than or equal to 10. In one particular embodiment, if N is equal to 6, M is equal to 1, 2 or 3.

In the (illustrative and non-limiting) example of FIG. 4, out of the seven colors C1 to C7 identified in the reference pattern, two colors C6 and C7 (represented by a black circle) are identified as being sensitive colors.

In the following determination step S4, an operator determines, using the set of devices 3, for each identified sensitive color C6, C7, a spot color, that is to say a color generated by an ink (which is pure or obtained from a mixture or possibly pure) that is printed in a single pass of the printing tool 6 (FIG. 3) and that is to reproduce the corresponding sensitive color C6, C7 exactly.

To this end, the determination step S4 comprises at least the sequence of the following sub-steps, implemented for each identified sensitive color C6, C7:
a sub-step S4A for preparing multiple inks of different colors, referred to as test colors CTi. Each ink having a given test color CTi is prepared from a mixture of available inks, having colors close to the sensitive color C6, C7 under consideration;
a sub-step S4B for measuring a color difference parameter (preferably deltaE, as explained below) of each of these test colors CTi of the prepared inks, with respect to the sensitive color C6, C7 under consideration; and
a sub-step S4C for selecting the test color CTi having the lowest color difference parameter value as spot color.

In sub-step S4A, an operator prepares inks of different colors, each of which has a particular color (corresponding to a test color CTi). To this end, they use a conventional device 22 (forming part of the set of devices 3 (FIG. 2)) to produce this type of ink mixture, and they use inks from among those available. For each test ink, a particular mixture of certain inks (from among these available inks) is produced. Generally speaking, the mixture is thus produced from a plurality of inks of different colors, using given mass percentages for each of the inks used.

However, in one highly specific case, if there is an ink having a color very close to the sensitive color, it is possible to use this “pure” ink directly (without mixing it with other inks), the color of this “pure” ink representing the test color CTi in this case.

In sub-step S4B, a color difference parameter with respect to the sensitive color C6, C7 is determined using measurements carried out by way of a colorimetric device 23 (FIG. 2), such as a spectrophotometer or colorimeter, for each of the test colors CTi.

Preferably, this color difference parameter represents a parameter referred to as deltaE (or ΔE), which is obtained from measurements carried out using the colorimetry device 23. A deltaE value represents information about the difference between two colors in a given color space.

To this end, in sub-step S4B, the following operations are carried out, for each test color CTi:
measuring the test color CTi of a sample of the ink, using the colorimetry device 23. To this end, as is conventional, the ink (having the test color under consideration) is deposited on a printing medium, preferably a plate having a color and a material similar to those of the object on which the printing will be carried out, and the colorimetry device 23 is brought above this printing medium and carries out a measurement. This measurement makes it possible to determine the coordinates of the test color in the color space described above;
calculating the differences between the coordinates, in this color space, of the test color CTi and of the corresponding sensitive color C6, C7. The coordinates of the sensitive color C6, C7, in the color space, were determined beforehand, in the analysis step S2; and
calculating deltaE (ΔE) from the differences between the coordinates of the test color CTi and of the sensitive color C6, C7, using a conventional and known mathematical formula, for example the following formula:

$$Δ E {*}_{76} = \sqrt{{( {L}_{2} * - {L}_{1} * )}^{2} + {( {a}_{2} * - {a}_{1} * )}^{2} + {( {b}_{2} * - {b}_{1} * )}^{2}}$$

where L₁*, a₁* and b₁* are the coordinates, in the color space, of the first color to be compared and L₂*, a₂* and b₂* are those of the second color.

The test color ultimately selected in sub-step S4C from among those specified in sub-step S4A is the test color whose deltaE (with respect to the sensitive color C6, C7 under consideration) is the lowest, namely the one closest to the sensitive color C6, C7.

FIG. 5 shows part 20 of the color space 19 from FIG. 4 around the sensitive color C6 of the reference pattern. The test colors CT1, CT2 and CT3 have been localized in this part 20 (at the coordinates measured in sub-step S4B). In this example, the test color CT2 is the color closest to the sensitive color C2. This test color CT2 is therefore selected as spot color.

In one variant embodiment, the determination step S4 (that is to say the sequence of sub-steps S4A, S4B and S4C) is reiterated if the lowest deltaE remains greater than a predetermined value, for example 2. In this variant, the determination step S4 (that is to say the sequence of sub-steps S4A, S4B and S4C) is reiterated until the deltaE becomes less than or equal to the predetermined value.

The operator enters the one or more spot colors thus determined into the computer device 2, for example using a conventional data entry unit, which forms part of a human-machine interface (HMI) 18 of the computer device 2 (FIG. 2).

Next, the computing unit 12 of the computer device 2 defines a plurality of sets of colors in the definition step S5.

Each of these sets of colors comprises N different colors. More precisely, each of these sets of colors comprises the M spot colors determined beforehand, such as the color CT2, along with N-M colors referred to as elementary colors. The N-M elementary colors are intended to be used as process colors.

In one preferred embodiment, the elementary colors comprise at least some of the following colors:
primary colors: cyan, magenta, yellow;
secondary colors: orange, green, purple;
black.

Furthermore, in one particular embodiment, one, several or all of the M spot colors may be taken into consideration in the set of colors to also be used, in addition to usual use as a spot color (that is to say to print a color in a single pass of the printing tool), as a process color, that is to say they may be combined with one or more of the other process colors so as to form a given color (via printing series of dots of these different process colors).

This particular embodiment, by making it possible to have a greater number of process colors, makes it possible to increase color combination options and thus the possibility of reproducing the colors of the reference pattern exactly.

Next, the selection unit 13 of the computer device 2 selects, in the selection step S6, one of the sets of colors (defined in the definition step S5), taking into account at least one selection criterion, as explained below.

The set of colors that is selected by the selection unit 13 represents the optimized set of colors, as determined by the method P.

In a first embodiment, the selection unit 13 uses, as a selection criterion, what is referred to as a precision criterion that reflects the precision of the livery obtained by a set of colors with respect to the reference pattern.

In this first embodiment, the selection step S6 comprises:
a sub-step S6A for determining a value of the precision criterion for each of the sets of colors defined in the definition step S5; and
a sub-step S6B for comparing the values of the precision criterion of each of the sets of colors with one another, and for selecting the set of colors whose precision criterion value reflects the best precision.

The precision criterion is formed so as to be able to determine the best precision between the livery obtained by a set of colors and the reference pattern. To this end, for each of the sets of colors, the values of a color difference parameter (preferably the values of deltaE) are determined for all of the colors of this set of colors. Thus, in one particular embodiment, the precision criterion of a first set takes into account the values of the deltaE of the various colors of this set (with respect to the colors of the reference pattern that they are to reproduce); similarly, the precision criterion of a second set takes into account the values of the deltaE of the various colors of this second set, and so on.

In sub-step S6B, the selection unit 13 compares the values of the precision criterion of all of the sets of colors under consideration with one another, and selects the set of colors whose precision criterion value reflects the best precision.

Furthermore, in a second embodiment, the selection step S6 uses, as a selection criterion, what is referred to as a consumption criterion that reflects the consumption of ink used, for each of the sets of colors defined in the definition step S5, to print the reference pattern.

The consumption criterion may represent the total volume of ink used by the N print heads (for the set of colors under consideration) to print the reference pattern on the object.

As a variant, the consumption criterion may represent the overall financial cost of the various inks used (for the set of colors under consideration), some inks possibly being more expensive than others.

In another variant, the consumption cost may represent the volume or financial cost of only some of the inks in the set of colors.

In this second embodiment, the selection step S6 comprises:
a sub-step S6C for determining a value of the consumption criterion for each of the sets of colors defined in the definition step S5; and
a sub-step S6D for comparing the values of the consumption criterion of each of the sets of colors with one another and for selecting the set of colors whose consumption criterion value reflects the lowest consumption, for example in terms of ink volume and/or financial cost.

Moreover, in a third embodiment, the selection unit 13 uses the above two criteria, namely the precision criterion and the consumption criterion.

Finally, the set of colors (which is selected by the selection unit 13 and which represents the optimized set of colors as determined by the method P) is provided to an operator, for example by being displayed on a screen (of the human-machine interface 18 of the computer device 2), by being stored on a removable memory, by being printed or being transmitted to a user device (not shown), for example a computer, of the operator.

In one particular embodiment of the computer device 2:
the analysis unit 11, the computing unit 12 and the selection unit 13 form part of a data processing unit 14; and
the reception unit 10 and the transmission unit 15 form part of a conventional communication system 16 enabling the computer device 2 to communicate with devices external to the computer device 2, via a wired or non-wired link.

The various elements and/or units of the computer device 2 may correspond to any type of processor able to implement the corresponding processing and computing operations.

FIG. 4 shows, in the color space 19, a reduced color space 21 that represents the color space able to be obtained by the colors of the optimized set of colors as determined by the method P. In one particular case, if a color, such as the color CA in FIG. 4, of the reference pattern cannot be obtained with the set of colors, the color closest in the color space 21 defined by this set of colors is printed, namely the color CB in this particular example of FIG. 4.

The method P and the system 1 as described above thus have numerous advantages. In particular, they make it possible:
to maximize the precision of the colors, that is to say they make it possible
to obtain precisely the desired colors in the livery; and
to minimize (or at the very least reduce) ink consumption.

The method P and the system 1 also have the following advantages:
no masking required for printing;
extensive customization;
reducing delays;
largely automatic and repeatable implementation for new objects, for example new aircraft, with new patterns to be reproduced; and
less dependence on ink suppliers (by producing ink mixtures).

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for determining an optimized set of N different ink colors to be used to print at least one reference pattern on an object, comprising:
an analysis step, implemented by a computer device, for analyzing colorimetric data relating to the reference pattern to be printed, in order to identify a set of colors to be printed;
an identification step for identifying, among this set of colors, a number M of sensitive colors, M being an integer greater than or equal to 1;
a determination step for determining, for each identified sensitive color, a spot color intended to reproduce the sensitive color, and for entering each spot color thus determined into the computer device;
a definition step, implemented by the computer device, for defining a plurality of sets of colors, each of the sets of colors comprising N different colors consisting of the M spot colors and N-M elementary colors, at least the N-M elementary colors being intended to be used as process colors; and
a selection step, implemented by the computer device, for selecting one of the sets of colors taking into account at least one selection criterion, the set of colors thus selected representing the determined optimized set.

2. The method according to claim 1, wherein the selection step uses, as a selection criterion, a precision criterion that reflects a precision of the livery obtained by a set of colors with respect to the reference pattern, and the selection step comprises:
a sub-step for determining a value of the precision criterion for each of the sets of colors defined in the definition step; and
a sub-step for comparing the values of the precision criterion of each of the sets of colors with one another, and for selecting the set of colors whose precision criterion value reflects the best precision.

3. The method according to claim 1, wherein the selection step uses, as a selection criterion, a consumption criterion that reflects ink consumption with regard to each of the sets of colors defined in the definition step, to print the reference pattern, the selection step comprising:
a sub-step for determining a value of the consumption criterion for each of the sets of colors defined in the definition step; and
a sub-step for comparing the values of the consumption criterion of each of the sets of colors with one another, and for selecting the set of colors whose consumption criterion value reflects the lowest consumption.

4. The method according to claim 1, wherein the determination step comprises sub-steps for determining a spot color for each selected sensitive color, comprising:
a sub-step for preparing multiple inks of different test colors, each time from a mixture of available inks, having colors close to the sensitive color under consideration;
a sub-step for measuring a value of a color difference parameter of each of these test colors of the prepared inks, with respect to the sensitive color; and
a selection sub-step for selecting a test color having a lowest color difference parameter value as spot color.

5. The method according to claim 4, wherein the color difference parameter is deltaE.

6. The method according to claim 1, wherein at least one spot color of the set of colors is taken into consideration in the set of colors to also be used as a process color.

7. The method according to claim 1, comprising a reception step, prior to the analysis step, in which the computer device receives the colorimetric data of the reference pattern to be printed.

8. The method according to claim 1, wherein the elementary colors comprise at least some of:
primary colors: cyan, magenta, yellow;
secondary colors: orange, green, purple;
black.

9. A printing method for printing a reference pattern on an object, using a printing system comprising at least one printing tool using N inks, wherein the printing tool uses, as N inks, respectively, the N inks selected beforehand using the method according to claim 1.

10. A system for determining an optimized set of N different ink colors to be used to print at least one reference pattern, on an object, comprising at least:
a computer device configured at least:
to analyze colorimetric data relating to the reference pattern to be printed, in order to identify a set of colors to be printed;
to define a plurality of sets of colors, each of the sets of colors comprising N different colors consisting of M spot colors and N-M colors referred to as elementary colors, at least the N-M elementary colors being intended to be used as process colors; and
to select one of the sets of colors taking into account at least one selection criterion, the set of colors thus selected representing the determined optimized set; and
a set of devices configured at least to determine, for each of a plurality of identified sensitive colors, a spot color intended to reproduce the sensitive color, the plurality of sensitive colors being identified among the set of colors identified by the computer device.
